(19) United States
(12) Patent Application Publication
(10) Pub. No.: US 2024/0354643 A1
(43) Pub. Date: Oct. 24, 2024

(54) METHOD FOR ADJUSTING A NOISE GENERATED BY A DEVICE

(71) Applicant: Robert Bosch GmbH, Stuttgart (DE)

(72) Inventors: Thomas Alber, Filderstadt (DE); Andreas Henke, Ditzingen (DE); Carine Au, Stuttgart (DE); Dmitry Naumkin, St. Petersburg (RU); Felix Schorn, Renningen (DE); Florian Lang, Ludwigsburg (DE); Luis Augusto Huergo, Tuebingen (DE); Matthias Huber, St. Petersburg (RU); Michael Kuka, Waiblingen (DE)

(21) Appl. No.: 18/623,272

(22) Filed: Apr. 1, 2024

(30) Foreign Application Priority Data
Apr. 20, 2023 (DE) 10 2023 203 623.1

(51) Int. Cl. G06N 20/00

(52) U.S. Cl. CPC G06N 20/00

(57) ABSTRACT

A method for adjusting a noise generated by a device. The method includes: ascertaining, for each device feature, a dependence of a contribution of the device feature to a noise evaluation characteristic number on the value of the device feature by training an EBM with combinations of values for the device features and, for each of the combinations, an associated value of the noise evaluation characteristic number, each of a plurality of decision trees of the EBM ascertaining a contribution to the noise evaluation characteristic number for a device that has the value for the device feature; ascertaining values of the device features for a device of which the noise is to be adjusted; ascertaining changes for one or more of the device features to the values of the device features for improving the noise evaluation characteristic number; and adjusting the device according to the ascertained changes.

### CROSS REFERENCE

The present application claims the benefit under 35 U.S.C. § 119 of German Patent Application No. DE 10 2023 203 623.1 filed on Apr. 20, 2023, which is expressly incorporated herein by reference in its entirety.

### FIELD

The present invention relates to methods for adjusting a noise generated by a device.

### BACKGROUND INFORMATION

In many products that are produced, such as cars but also other (in particular mechanical) devices, the noise that the products generate during operation is of importance since they are not to generate noise that is unpleasant for humans. For a given device, it must first be ascertained for this purpose how the noise generated by it is to be evaluated and also how it has to be adjusted so that the noise changes in a suitable manner, i.e., actually becomes more pleasant for humans. Efficient procedures are desirable for this purpose.

### SUMMARY

According to various embodiments of the present invention, a method for adjusting a noise generated by a device is provided, comprising: ascertaining, for each device feature of a plurality of device features, a dependence of a contribution of the device feature to a (device) noise evaluation characteristic number on the value of the device feature by training an explainable boosting machine (EBM) with a plurality of combinations of values for the device features and, for each of the combinations, an associated value of the noise evaluation characteristic number, wherein each of a plurality of decision trees of the explainable boosting machine ascertains, depending on the value of a device feature assigned to the decision tree, a contribution to the noise evaluation characteristic number (performance characteristic number or quality characteristic number, e.g., KPI (key performance indicator)) for a device that has the value for the device feature; ascertaining values of device features for a device of which the noise is to be adjusted; ascertaining, from the dependences ascertained for the device features, changes, for one or more of the device features, to the values of the device features for improving the noise evaluation characteristic number; and adjusting the device of which the noise is to be adjusted, according to the ascertained changes.

By means of the EBM (or the dependences ascertained by means of the training of the EBM), the method described above according to the present invention makes it possible to determine a noise evaluation characteristic number with higher accuracy than regression approaches by means of linear regression on the basis of psychoacoustic variables. Furthermore, the EBM provides dependences between device features and their contributions to the noise evaluation characteristic number. In other words, the EBM provides the information as to how the value of a device feature influences the noise evaluation characteristic number. The noise can thus be adjusted efficiently by changing the device features (which have a sufficiently strong effect on the noise), as specified by the dependences ascertained for them (i.e., their influence on the noise evaluation characteristic number).

The above-described method of the present invention thus makes a precise evaluation of product noises and an effective product optimization for obtaining a product with more pleasant acoustic properties possible.

Various exemplary embodiments of the present invention are specified below.

Exemplary embodiment 1 is a method for adjusting a noise generated by a device, as described above.

Exemplary embodiment 2 is a method according to exemplary embodiment 1, wherein the device features are order amplitudes of an order spectrum or frequency amplitudes of a frequency spectrum of noises, and the values of the device features that are ascertained are the order amplitudes or frequency amplitudes of the noise that is to be adjusted.

The use of order amplitudes and frequency amplitudes makes effective noise adjustment possible since orders and frequencies can typically be assigned to components (gear wheels, etc.).

Instead of frequencies or orders, other device features, such as octave spectra or grid parts of a 3D spectrum can also be used for other applications.

Exemplary embodiment 3 is a method according to exemplary embodiment 1 or 2, wherein the device of which the noise is to be adjusted is a vehicle.

In particular in such a context, i.e., for adjusting the noise development of a vehicle (car, e-bike, . . . ), the procedure described above makes an efficient procedure possible. However, the method described above can also be applied to devices other than vehicles, such as domestic appliances (coffee machines, refrigerators, . . . ) or electrical tools, etc. In particular, the noise development can be adjusted during the use of the device. This can, for example, take place by an actuator system, such as an active noise control unit, which is controlled appropriately in order to generate a sound opposite to the noise development and preferably to inject it into the device.

Exemplary embodiment 4 is a method according to one of exemplary embodiments 1 to 3, comprising ascertaining, for each combination of values for the device features, an associated value of the noise evaluation characteristic number by carrying out a jury test for the combination.

In this way, expert knowledge is ascertained, specifically as to how humans assess a particular noise, which is then used to train the EBM so that the EBM realistically assesses noises, i.e., can assess whether the noise is pleasant or unpleasant for humans. For example, jury tests are carried out for a few hundred microphone signals of product noise measurements in order to determine the noise evaluation characteristic numbers for the combinations (i.e., the labels for the training data elements). After training with this expert knowledge, the EBM makes a reliable, highly accurate determination of the noise evaluation characteristic number and its dependence on the device features possible.

Exemplary embodiment 5 is a method according to one of exemplary embodiments 1 to 4, wherein the changes are ascertained by ascertaining the contributions of the ascertained values of the device features for the devices from the ascertained dependences to the noise evaluation characteristic number, a ranking order of the device features is ascertained according to the contributions thereof to the noise evaluation characteristic number, and the one or more of the device features for which changes are ascertained from the dependences are determined according to the ranking order.

In other words, the device features are considered for possible changes that provide a higher contribution (than others of the device features) to the noise evaluation characteristic number.

The EBM provides this ranking order of importance of the device features (feature importance) and thus makes a purposeful change of the device features possible.

Exemplary embodiment 6 is a production system that is configured to carry out a method according to one of exemplary embodiments 1 to 5.

Exemplary embodiment 7 is a computer program comprising instructions that, when executed by a processor, cause the processor to carry out a method according to one of exemplary embodiments 1 to 5.

Exemplary embodiment 8 is a computer-readable medium storing instructions that, when executed by a processor, cause the processor to carry out a method according to one of exemplary embodiments 1 to 5.

In the figures, similar reference signs generally refer to the same parts throughout the various views. The figures are not necessarily true to scale, with emphasis instead generally being placed on the representation of the principles of the present invention. In the following description, various aspects are described with reference to the figures.

### BRIEF DESCRIPTION OF THE DRAWINGS

FIG. 1 illustrates a procedure for evaluating product noises and for product optimization for obtaining a product with more pleasant acoustic properties, according to an example embodiment of the present invention.

FIG. 2 illustrates a sensitivity analysis, according to an example embodiment of the present invention.

FIG. 3 illustrates the training of an EBM for evaluating noises of a device, according to an example embodiment of the present invention.

FIG. 4 illustrates the training of an EBM, according to an example embodiment of the present invention.

FIG. 5 illustrates the determination of a KPI from a microphone signal, according to an example embodiment of the present invention.

FIG. 6 shows a diagram of the dependence of the contribution of an order to the KPI, according to an example embodiment of the present invention.

FIG. 7 shows a flowchart illustrating a method for adjusting a noise generated by a device, according to an example embodiment of the present invention.

### DETAILED DESCRIPTION OF EXAMPLE EMBODIMENTS

The following detailed description relates to the figures, which show, by way of explanation, specific details and aspects of this disclosure in which the present invention can be executed. Other aspects may be used and structural, logical, and electrical changes may be performed without departing from the scope of protection of the present invention. The various aspects of this disclosure are not necessarily mutually exclusive, since some aspects of this disclosure may be combined with one or more other aspects of this disclosure to form new aspects.

Various examples are described in more detail below.

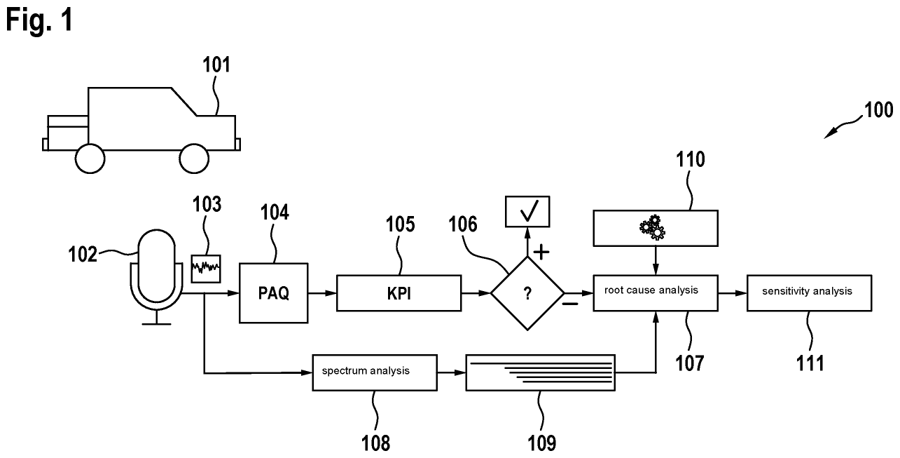

FIG. 1 illustrates a procedure for evaluating product noises and for product optimization for obtaining a product with more pleasant acoustic properties:

The noises generated by a device 101 (e.g., a product), in this case a car, are measured in an acoustic laboratory by means of a microphone 102. From the microphone signal 103 generated by the microphone 102, a KPI 105 (key performance index; in other words, a (noise) evaluation characteristic number) is ascertained, which describes the acoustic properties (i.e., the noise behavior) of the device 101 (e.g., by a single value). For this purpose, particularly in connection with legal requirements, e.g., the indication of the sound level in dB (A), such as for the EU tire label for characterizing the sound volume of tires (in this case, the device would be only one tire, for example).

However, when determining the feeling of well-being (hereinafter also referred to as “pleasantness”) of a product noise, purely physical evaluations by means of sound level typically do not suffice, but psychoacoustic characteristic values (PAQs) 104, such as loudness, sharpness or roughness, are used for ascertaining the KPI 105 since these characteristic values better correlate with human perception. The use of only one of these psychoacoustic values is however often insufficient. Instead, it is necessary to carry out jury tests with test subjects who evaluate the product sounds using a scale of musical notes. After numerous jury tests have been carried out for a product class, it is possible to form a regression formula (metric) on the basis of the psychoacoustic characteristic values 104 and thus to calculate the KPI 105 therefrom, e.g., in the form “KPI=3.2×loudness+0.2×sharpness.” Since this metric (i.e., the calculation rule for the KPI 105) is available, it can be used to evaluate noises.

In the product development process, after the calculation of the KPI 105 for a device (product) 101, this value is typically compared to a corresponding requirement for the device (comparison 106). If the requirement is met, the device 101 does not need to be adjusted with regard to its noise development. In the event that the requirement is not met (i.e., a required KPI is not reached), an acoustic expert has the task of carrying out a root cause analysis 107 and of deriving improvement measures therefrom. Different analyses are used for the root cause analysis 107, e.g., a spectrum analysis 108 of the microphone signal in the form of a frequency analysis (for product testing of motor-transmission units at constant rotational speed) or an order analysis (in the case of investigations with rotational speedups). The result is a spectrum 109. It is assumed below that an order analysis is used, i.e., the result is an order spectrum, which indicates an amplitude for each order. An order generates a particular (noise pulse) frequency for a particular rotational speed according to the correlation

frequency=order×rotational speed.

An order can be assigned to one or more components, e.g., a gear wheel with 13 teeth of the order 13.

The ascertained order amplitudes can be assigned to individual components of the devices by means of design information 110 (i.e., information about the design of the device 101, such as the number of teeth of the gear wheels, specification of ball bearings, etc.), for example a particular order (and the order amplitude ascertained for it) to a specific gear wheel in a transmission of a vehicle.

The order spectrum 109 is a purely physical description of the noise behavior of the device 101. Human perception is not taken into account. If, for example, an order amplitude is higher than all others, this does not necessarily mean that this order amplitude is also the most unpleasant for humans. This is, for example, the case if this order amplitude is in a frequency range in which human hearing is rather insensitive.

For example, an iterative process in the sense of a sensitivity analysis 111 is therefore carried out.

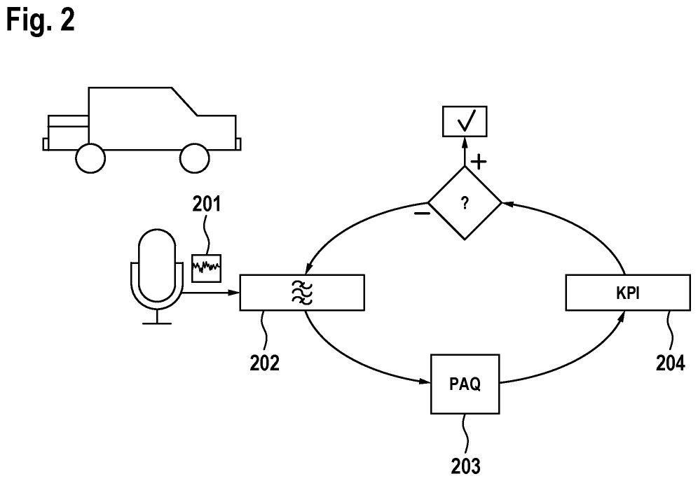

FIG. 2 illustrates a sensitivity analysis.

During the sensitivity analysis, orders with a higher amplitude are decreased stepwise by filtering 202 the microphone signal 201, and, after each filtering, the KPI 204 is ascertained again (as described above on the basis of a calculation of PAQs 203) in order thereby to evaluate the importance of different orders to the KPI 204 and to ascertain a possibility for achieving the requirement (i.e., typically a KPI target value which is used for the comparison for each filtering (comparison 204)).

The sensitivity analysis is typically carried out by an acoustic expert. Thereafter, the feedback to the product development takes place as to which component(s) of the product 101 has/have to be optimized in order to achieve the target value.

For example, the following steps are thus carried out within the framework of the development of a pleasant-sounding product:
(1) ascertaining an evaluation characteristic number (KPI), e.g., for feeling of well-being (“pleasantness”) or also “forcefulness” (e.g., in a sports car) of the product sound
(2) ascertaining the orders important (most disturbing) to human perception
(3) determining the required amplitude reduction for disturbing orders in order to achieve the required KPI value

According to various embodiments, machine learning (ML), specifically an explainable boosting machine (EBM), is used for the above steps. This makes it possible to dispense with a sensitivity analysis as in FIG. 2 with a plurality of filter operations (in a plurality of iterations). In addition, the KPI 105 can be precisely ascertained using the EBM.

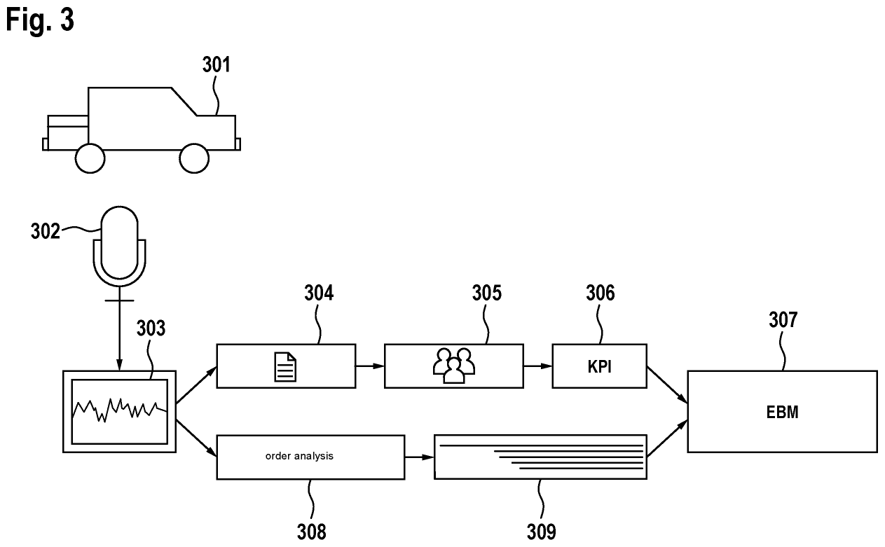

FIG. 3 illustrates the training of an EBM 307 for an evaluation of noises of a device (of a particular device class, e.g., vehicles) and possibly adjustment of the device in order to improve the noises (i.e., make them more pleasant for humans).

For a plurality of devices 301 of the device class (for example for different vehicles) and possibly also a plurality of noise measurements per device 301, a microphone signal 303 is generated in each case by means of a microphone 302 (i.e., a respective measurement is carried out). Each microphone signal 303 is stored in an audio file 304 and an evaluation (i.e., a KPI) 306 of the respective noise is ascertained by means of a jury test 305. In addition, as explained above, an order analysis 308 for the noise is carried out in order to ascertain an order spectrum 309.

These items of information 306 and 309 collected for the devices 301 serve as training data for the EBM 307. Specifically, each order spectrum (i.e., the order spectrum for a noise) forms a training input (a respective training data element) and the KPI 306 for the noise forms the target output for the order spectrum (in other words, the label for the respective order spectrum).

An explainable boosting machine (EBM) is a boosting-based machine learning model that uses an additive model structure in order to model complex correlations between features and labels. The model uses a combination of decision trees to partition the features, and linear models to weight the output of each subtree. An explainable boosting machine (EBM) is based on gradient boosting, a specific form of boosting, in which each new weak learner (specifically here a decision tree) corrects the residual of the previous learner. In contrast to other gradient boosting models, however, an EBM uses an additive model structure, which combines decision trees and linear models in order to model complex correlations between features and labels.

In the present example, the features are the order amplitudes from the order spectrum for a noise and the associated label of the KPI of the noise. A simple example of training an EBM 400 is described below.

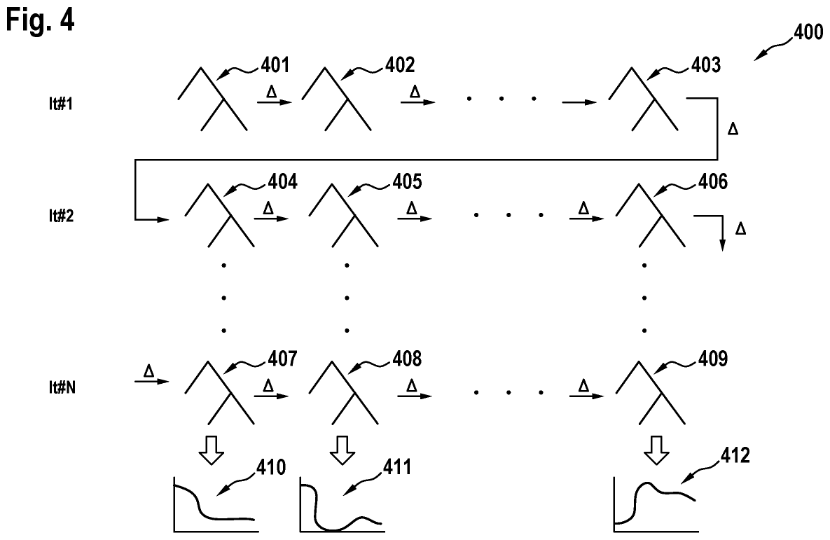

FIG. 4 illustrates the training of an EBM 400.

As mentioned above, the EBM has a plurality of decision trees 401, 402, 403, wherein each decision tree 401 is associated with a feature. In the present example, each feature is an order, i.e., the first (leftmost) decision tree 401 receives as input the order amplitude for a first order of the order spectrum 309, the second (second from the left) decision tree 402 receives as input the order amplitude for a second order of the order spectrum 309, etc., up to the k-th decision tree 403.

The first decision tree 401 is selected (and trained) with the goal that it determines the correct KPI (i.e., the label of the respective training data element) for each of the training data elements from the corresponding order amplitude of the first order. If, for a noise, the order amplitude of the first order for this noise (given by the order spectrum 309 ascertained for this noise) is now supplied to the first decision tree 401, the first decision tree 401 thus outputs a certain estimate of the KPI. The comparison of this estimate to the “correct” KPI per training data element provides a certain error (delta) per training data element (since it is highly probable that the first decision tree cannot determine the correct KPI solely from the first order amplitude). The second decision tree 402 uses a different order, and only this order, to model (i.e., predict) the still unpredictable part of the KPI, i.e., the delta, for each training data element. The still remaining and still unsatisfactorily predictable part of the KPI (per training data element) serves as a target variable for the training of the next decision tree (and thus the next input variable, i.e., in this case, the next order amplitude). This procedure is repeated up to the last input variable.

After this run is concluded for all decision trees, a still unsatisfactorily predicted part of the KPI remains. This part serves as a target variable in a second iteration It #2 for a new decision tree 404 for the first input variable (i.e., first order amplitude). The training is continued correspondingly up to the N-th iteration so that a respective chain (sequence) of decision trees is generated for each device feature (i.e., in the current example, for each order).

When all decision trees 401 to 409 have been trained, each decision tree provides its (partial) contribution to a KPI estimate for an order amplitude supplied to it.

If the sequence of the decision trees 401, 404, 407 is now considered, these decision trees represent the correlation between the first order and the KPI.

Analogously, further diagrams 411, 412 represent the dependences of the KPI contribution of the other orders on the respective order amplitudes. These dependences can be considered as a result of the training, i.e., the actual decision trees 401 to 409 are not used further.

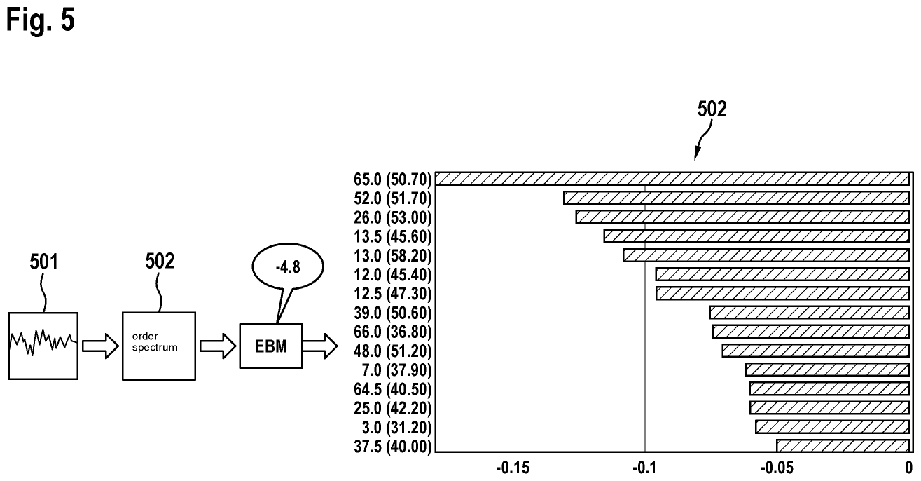

FIG. 5 illustrates the determination of a KPI from a microphone signal 501.

As explained above, an order spectrum 502 is first ascertained from the microphone signal 501. By means of the dependences shown in the diagrams 4010 to 412, a respective contribution to a KPI estimate can then be ascertained for each order. For example, the order 65 of which the order amplitude (level) for the current noise is 50.7 dB provides approximately a contribution of −0.2 to the KPI estimate.

The above procedure thus provides a quantification of the contribution of each individual order to the KPI, which can be arranged accordingly (into a feature ranking order 502), as shown in FIG. 5: The order 65 provides the highest contribution here, for example. In addition to the KPI (here −4.8), the EBM thus also provides the importance of each feature, i.e., of the order, to this overall score. It is thus directly apparent which orders are most important (most unpleasant) for humans. The knowledge is thereby obtained as to which orders and thus which transmission stages, for example, have to be improved in particular in order to achieve a more pleasant product noise.

In this case, the ascertained dependences (diagrams 410 to 412) can also be used to ascertain to what extent a KPI improvement can be achieved by reducing the amplitude of a particular order, as explained below for such a diagram, which is shown in greater detail.

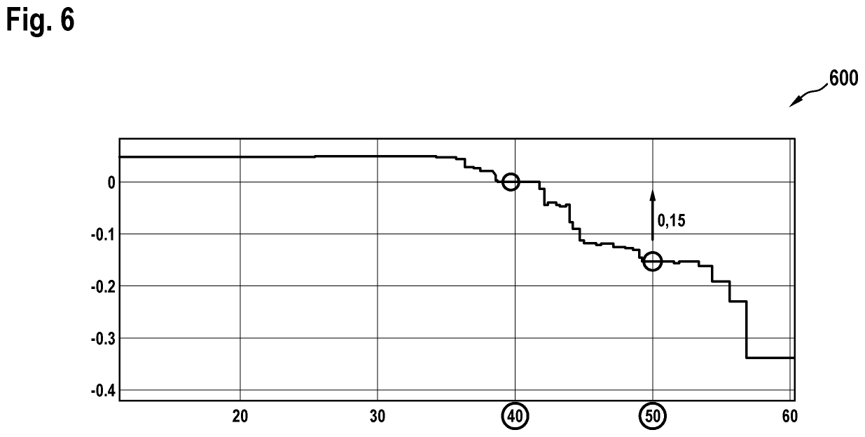

FIG. 6 shows a diagram 600 of the dependence of the contribution to the KPI on the amplitude of the 65^{th} order.

The diagram 600 can be understood as a partial contribution plot. This can be used to directly ascertain how much the KPI improves if the amplitude of the corresponding order (here the 65^{th}) is reduced by a defined amount. Here, the KPI improves by 0.15 if the amplitude of the order is reduced from 50 dB to 40 dB.

With the trained EBM (in particular the dependences of the KPI contributions on the order amplitudes for the different orders), it is thus possible, in the sense of a sensitivity analysis, to directly determine the effect on the KPI for a reduction in the amplitude of one or more orders by a certain amount, without complex filtering of the microphone signal (as in the example of FIG. 2) being necessary. This is particularly relevant since not only one order is often conspicuous, but rather numerous orders have to be reduced stepwise and their interaction must also be taken into consideration in order to allow balanced, cost-effective product optimization. This means that it is generally not expedient to extremely decrease an amplitude of one order, while other order amplitudes and thus components are not taken into account. Therefore, the procedure described with reference to FIG. 2 is extremely complex because many filter iterations are necessary.

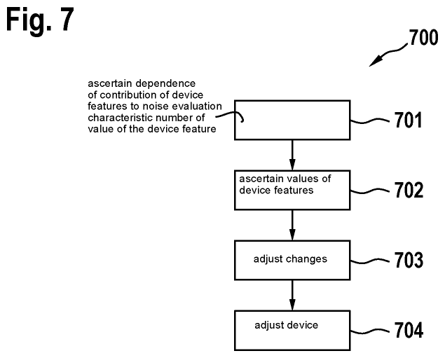

In summary, according to various embodiments, the procedure is as described below with reference to FIG. 7.

FIG. 7 shows a flowchart 700 illustrating a method for adjusting a noise generated by a device.

In 701, for each device feature of a plurality of device features, a dependence of a contribution of the device feature to a (device) noise evaluation characteristic number on the value of the device feature is ascertained by training an explainable boosting machine (EBM) with a plurality of combinations of values for the device features (i.e., each combination contains a value for each of the device features) and, for each of the combinations, an associated value of the noise evaluation characteristic number is ascertained.

In this case, each of a plurality of decision trees of the explainable boosting machine ascertains, depending on the value of a device feature assigned to the decision tree, a contribution to the noise evaluation characteristic number (performance characteristic number or quality characteristic number, e.g., KPI) for a device that has the value for the device feature. As described with reference to FIG. 4, a plurality of decision trees may in this case be assigned to the same device feature (i.e., there is typically a sequence of decision trees for each device feature with a decision tree per training iteration of the EBM). The contribution of a device feature to the noise evaluation characteristic number is the sum of the contributions to the noise evaluation characteristic number that are provided by the decision trees assigned to the device feature. It can thus also be said that each decision tree assigned to a device feature ascertains a partial contribution of the device feature to the noise evaluation characteristic number, and the total contribution of the device feature to the noise evaluation characteristic number is the sum of the partial contributions ascertained by the decision trees assigned to the device feature.

In 702, values of the device features are ascertained for a device of which the noise is to be adjusted.

In 703, from the dependences ascertained for the device features, changes, for one or more of the device features, to the values of the device features for improving the noise evaluation characteristic number (of the device of which the noise is to be adjusted; this noise evaluation characteristic number can likewise be ascertained with the aid of the ascertained dependences) are ascertained.

In 704, the device of which the noise is to be adjusted is adjusted according to the ascertained changes.

For example, as described above, time signals of product noises recorded by means of a microphone within the framework of measurements are converted into an order spectrum by means of an order analysis. Each order represents an input feature for the training of an explainable boosting machine. In order to create labels, the time signals are used as audio files in a jury test in which test subjects have to provide an evaluation with respect to the, e.g., the [sic]¹ “pleasantness” of the product noises. The evaluation (KPI) for the product noises ascertained in this way is used as a label for the training of the explainable boosting machine (see also FIG. 3). ¹ [Translator's note: “die” (“the”) has either been duplicated in error or there appears to be something missing here.]

After successful completion of the training of the explainable boosting machine (EBM), the ML model (i.e., the EBM) is available for the evaluation of new product noises, i.e., further products can be measured with a microphone. From the time signal of the microphone, order spectra are formed, and these order spectra are used as input for the EBM. The EBM then provides an evaluation for the respective (new) product noise without further jury tests being necessary. Furthermore, the EBM provides the ranking order of the importance of the orders and, for each order, the dependence of the KPI contribution on the amplitude of the order.

Due to the availability of this dependence, it is easily possible to carry out sensitivity analyses. For this purpose, amplitudes of the orders are reduced and the influence on the KPI is evaluated directly without complex signal filtering being required.

In the above examples, it was described how the invention can be used to increase the “pleasantness” of a product noise as a KPI in product development. However, the procedure of FIG. 7 can also be used for further applications: Within the framework of sound design, the KPI may also be a KPI such as a forcefulness, quality impression, etc. The description of the noise could in this case take place through psychoacoustic variables instead of via order spectra (or also frequency spectra that can be used in the above examples analogously to the order spectra). Their importance to the attribute of interest then provides information about the direction in which a product sound must be changed in order to amplify or attenuate the attribute of interest. For example, it could thus be ascertained that it is necessary to increase the psychoacoustic variable of roughness in order to obtain a more forceful sound. In addition to purely (psycho) acoustic input features, it is also possible and possibly reasonable to use non-acoustic characteristic values as inputs of the EBM. An example in this respect is the noise classification of tires. The KPI in this case is, for example, the noise level in dB which is to be indicated on the EU tire label. In this example, input features could, for example, be the groove depth and groove width of the tires or the amounts of different substances for the tire mix. An EBM trained according to the above-described procedure makes it possible to ascertain the most important influencing factors on the noise level of the tires and to derive targeted improvement measures.

The method in FIG. 7 can be carried out by one or more computers with one or more data processing units. The term “data processing unit” may be understood as any type of entity that enables processing of data or signals. The data or signals can be treated, for example, according to at least one (i.e. one or more than one) special function which is performed by the data processing unit. A data processing unit can comprise or be formed from an analog circuit, a digital circuit, a logic circuit, a microprocessor, a microcontroller, a central processing unit (CPU), a graphics processing unit (GPU), a digital signal processor (DSP), an integrated circuit of a programmable gate array (FPGA) or any combination thereof. Any other way of implementing the respective functions described in more detail herein may also be understood as a data processing unit or logic circuit assembly. One or more of the method steps described in detail here can be executed (e.g. implemented) by a data processing unit by one or more special functions that are performed by the data processing unit. 5

The method is therefore in particular computer-implemented according to various embodiments.

What is claimed is:

1. A method for adjusting a noise generated by a device, comprising the following steps:
ascertaining, for each device feature of a plurality of device features, a dependence of a contribution of the device feature to a noise evaluation characteristic number on a value of the device feature by training an explainable boosting machine with a plurality of combinations of values for the device features and, for each of the combinations, an associated value of the noise evaluation characteristic number, wherein each of a plurality of decision trees of the explainable boosting machine ascertains, depending on the value of a device feature assigned to the decision tree, a contribution to the noise evaluation characteristic number for the device that has the value for the device feature;
ascertaining values of the device features for a device of which the noise is to be adjusted;
ascertaining, from the dependences ascertained for the device features, changes, for one or more of the device features, to the values of the device features for improving the noise evaluation characteristic number; and
adjusting the device of which the noise is to be adjusted, according to the ascertained changes.

2. The method according to claim 1, wherein the device features are order amplitudes of an order spectrum or frequency amplitudes of a frequency spectrum of noises, and the values of the device features that are ascertained are the order amplitudes or frequency amplitudes of the noise that is to be adjusted.

3. The method according to claim 1, wherein the device of which the noise is to be adjusted is a vehicle.

4. The method according to claim 1, further comprising ascertaining, for each combination of values for the device features, an associated value of the noise evaluation characteristic number by carrying out a jury test for the combination.

5. The method according to claim 1, wherein the changes are ascertained by ascertaining the contributions of the ascertained values of the device features for the devices from the ascertained dependences to the noise evaluation characteristic number, a ranking order of the device features is ascertained according to the contributions thereof to the noise evaluation characteristic number, and the one or more of the device features for which changes are ascertained from the dependences are determined according to the ranking order.

6. A production system configured to adjusting a noise generated by a device, the production system configured to:
ascertain, for each device feature of a plurality of device features, a dependence of a contribution of the device feature to a noise evaluation characteristic number on a value of the device feature by training an explainable boosting machine with a plurality of combinations of values for the device features and, for each of the combinations, an associated value of the noise evaluation characteristic number, wherein each of a plurality of decision trees of the explainable boosting machine ascertains, depending on the value of a device feature assigned to the decision tree, a contribution to the noise evaluation characteristic number for the device that has the value for the device feature;
ascertain values of the device features for a device of which the noise is to be adjusted;
ascertain, from the dependences ascertained for the device features, changes, for one or more of the device features, to the values of the device features for improving the noise evaluation characteristic number; and
adjust the device of which the noise is to be adjusted, according to the ascertained changes.

7. A non-transitory computer-readable medium on which is stored instructions for adjusting a noise generated by a device, the instructions, when executed by a processor, causing the processor to perform the following steps:
ascertaining, for each device feature of a plurality of device features, a dependence of a contribution of the device feature to a noise evaluation characteristic number on a value of the device feature by training an explainable boosting machine with a plurality of combinations of values for the device features and, for each of the combinations, an associated value of the noise evaluation characteristic number, wherein each of a plurality of decision trees of the explainable boosting machine ascertains, depending on the value of a device feature assigned to the decision tree, a contribution to the noise evaluation characteristic number for the device that has the value for the device feature;
ascertaining values of the device features for a device of which the noise is to be adjusted;
ascertaining, from the dependences ascertained for the device features, changes, for one or more of the device features, to the values of the device features for improving the noise evaluation characteristic number; and
adjusting the device of which the noise is to be adjusted, according to the ascertained changes.
